(19) United States
(12) Patent Application Publication
(10) Pub. No.: US 2024/0339042 A1
(43) Pub. Date: Oct. 10, 2024

(54) AUTOMATICALLY CREATING PSYCHOMETRICALLY VALID AND RELIABLE ITEMS USING GENERATIVE LANGUAGE MODELS

(71) Applicant: University of South Florida, Tampa, FL (US)

(72) Inventors: John Licato, Tampa, FL (US); Antonio Vincent Laverghetta, JR., Spring Hill, FL (US)

(21) Appl. No.: 18/625,692

(22) Filed: Apr. 3, 2024

Related U.S. Application Data
(60) Provisional application No. 63/494,305, filed on Apr. 5, 2023.

(51) Int. Cl. G09B 7/00

(52) U.S. Cl. CPC G09B 7/00

(57) ABSTRACT

A system is developed employing deep neural networks from natural language processing for the automatic generation of test questions (items) for educational assessments. The system includes: at least one computing device; and a non-transitory computer-readable medium with computer-executable instructions stored thereon that when executed by the at least one computing device cause the at least one computing device to: receive a plurality of items; place the items of the plurality of items in an item bank; for each item in the item bank, generate a score for at least one psychometric property of the item; sort each item in the item bank based on the generated scores; generate a prompt for an item generator based on the sorted items; receive a generated set of items from the item generator based on the generated prompt; and add at least some of the generated set of items to the item bank.

### CROSS-REFERENCE TO RELATED APPLICATIONS

This application claims priority to, and benefit of, U.S. Provisional Patent Ser. No. 63/494,305 filed on Apr. 5, 2023, and titled “AUTOMATICALLY CREATING PSYCHOMETRICALLY VALID AND RELIABLE ITEMS USING GENERATIVE LANGUAGE MODELS.” The disclosure of which is hereby incorporated by reference in its entirety.

### BACKGROUND

In assessing how competent human beings are in certain areas, tests are often given that are designed by experts. The scientific field that studies whether those tests are able to consistently measure what they claim to measure (their reliability) and whether those tests are actually measuring the construct they were designed to (validity) is called “psychometrics.” Psychometricians have a variety of techniques to ensuring that questions on tests (called “items”) are reliable and valid, but these techniques require extensive empirical studies, often involving the administration of the items to thousands of human beings. This can be very expensive and time-consuming.

### SUMMARY

A system is developed employing deep neural networks from natural language processing (NLP) for the automatic generation of test questions (items) for educational assessments. The system uses the psychometric properties of existing items, including validity and reliability, as a criterion for optimizing quality in the generated item pool. Unlike the prior art, where optimization via such metrics is performed in only one step, or multi-step optimization is performed using non-psychometric criteria, our process can be run an arbitrary number of times, hence allowing for continuous iterative improvement in item quality. The system may be run in an online mode, whereby subject matter experts interact with the system's outputs and select the items to be fed back into the system for the next iteration. Alternatively, the system may run in an offline mode, in which case a separate item model is used for item quality estimation and selection.

In some aspects, the techniques described herein relate to a method including: receiving a plurality of items by a computing device; placing the items of the plurality of items in an item bank by the computing device; for each item in the item bank, generating a score for at least one psychometric property of the item by the computing device; sorting each item in the item bank based on the generated scores by the computing device; generating a prompt for an item generator based on the sorted items by the computing device; receiving a generated set of items from the item generator based on the generated prompt by the computing device; and adding at least some of the generated set of items to the item bank by the computing device.

In some aspects, the techniques described herein relate to a method, further including: for each item in the generated set of items, generating a score for at least one psychometric property of the item; filtering the generated set of items to remove items with generated scores that are below a threshold; and adding the remaining items from the generated set of items to the item bank.

In some aspects, the techniques described herein relate to a method, further including generating a test using at least some of the items in the item bank.

In some aspects, the techniques described herein relate to a method, wherein the items are test items.

In some aspects, the techniques described herein relate to a method, wherein the psychometric property includes one of difficulty, discrimination, and reliability.

In some aspects, the techniques described herein relate to a method, wherein the score is generated by an AI model.

In some aspects, the techniques described herein relate to a method, wherein the score is generated by an expert reviewer.

In some aspects, the techniques described herein relate to a method, wherein the item generator includes a large language model or another AI content generator.

In some aspects, the techniques described herein relate to a method, wherein the items include text items, image items, and video items.

In some aspects, the techniques described herein relate to a method, wherein generating the prompt for an item generator based on the sorted items includes: selecting the items from the item bank with the top-k scores; selecting the items from the item bank with the bottom-k scores; and generating the prompt for the item generator using the top-k scores and the bottom-k scores.

In some aspects, the techniques described herein relate to a system including: at least one computing device; and a non-transitory computer-readable medium with computer-executable instructions stored thereon that when executed by the at least one computing device cause the at least one computing device to: receive a plurality of items; place the items of the plurality of items in an item bank; for each item in the item bank, generate a score for at least one psychometric property of the item; sort each item in the item bank based on the generated scores; generate a prompt for an item generator based on the sorted items; receive a generated set of items from the item generator based on the generated prompt; and add at least some of the generated set of items to the item bank.

In some aspects, the techniques described herein relate to a system, further including: for each item in the generated set of items, generating a score for at least one psychometric property of the item; filtering the generated set of items to remove items with generated scores that are below a threshold; and adding the remaining items from the generated set of items to the item bank.

In some aspects, the techniques described herein relate to a system, further including generating a test using at least some of the items in the item bank.

In some aspects, the techniques described herein relate to a system, wherein the items are test items.

In some aspects, the techniques described herein relate to a system, wherein the psychometric property includes one of difficulty, discrimination, and reliability.

In some aspects, the techniques described herein relate to a system, wherein the score is generated by an AI model.

In some aspects, the techniques described herein relate to a system, wherein the score is generated by expert reviewer.

In some aspects, the techniques described herein relate to a system, wherein the item generator includes a large language model or another AI content generator.

In some aspects, the techniques described herein relate to a system, wherein generating the prompt for an item generator based on the sorted items includes: selecting the items from the item bank with the top-k scores; selecting the items from the item bank with the bottom-k scores; and generating the prompt for the item generator using the top-k scores and the bottom-k scores.

In some aspects, the techniques described herein relate to a non-transitory computer-readable medium with computer-executable instructions stored thereon that when executed by at least one computing device cause the at least one computing device to: receive a plurality of items; place the items of the plurality of items in an item bank; for each item in the item bank, generate a score for at least one psychometric property of the item; sort each item in the item bank based on the generated scores; generate a prompt for an item generator based on the sorted items by: selecting the items from the item bank with the top-k scores; selecting the items from the item bank with the bottom-k scores; and generating the prompt for the item generator using the top-k scores and the bottom-k scores; receive a generated set of items from the item generator based on the generated prompt; and add at least some of the generated set of items to the item bank.

Additional advantages will be set forth in part in the description that follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

It is to be understood that both the foregoing general description and the following detailed description are exemplary and explanatory only and are not restrictive of the systems and methods as claimed.

### BRIEF DESCRIPTION OF THE DRAWINGS

The accompanying figures, which are incorporated in and constitute a part of this specification, illustrate several aspects of the disclosure, and together with the description, serve to explain the principles of the disclosure.

The components in the drawings are not necessarily to scale relative to each other. Like reference numerals designate corresponding parts throughout the several views.

FIG. 1 is an environment including a system for generating items;

FIG. 2 is an illustration of an example prompt;

FIG. 3 is an illustration of example method for generating items; and

FIG. 4 illustrates an example computing device.

### DETAILED DESCRIPTION

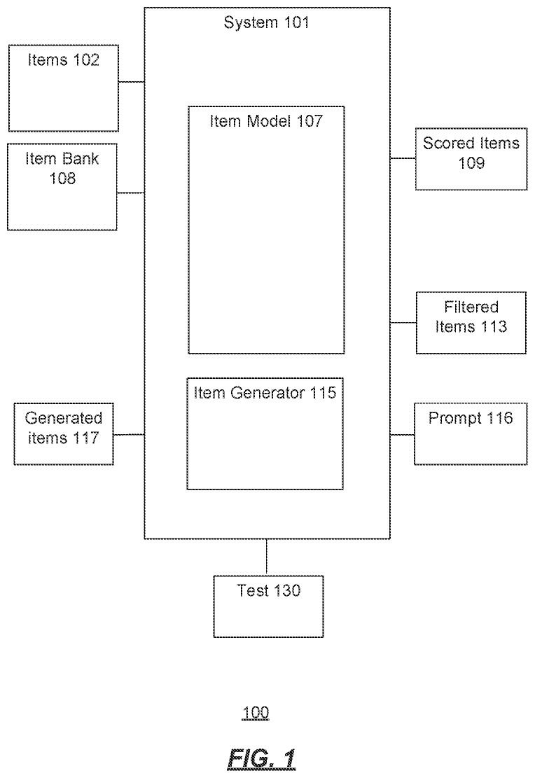

FIG. 1 is an environment 100 including a system 101 for generating items 102. In some embodiments, the items 102 may be test items 102 or questions. The test items 102 may be intended for use as questions in a test that is administered to a human to measure the competence of the human in a particular subject matter. Example tests include subject matter tests (e.g., math or science) that are administered to students and professional tests (e.g., accounting or medical) that are administered as part of licensing. Other types of tests may be supported. Note that the items 102 are not limited to test items or test questions, but may include image, audio, and video items 102, for example.

As described above, psychometrics generally refers to specialized fields within psychology and education devoted to testing, measurement, assessment, and related activities. The goal of the system 101 may be to automatically generate test items 102 that have high psychometric properties and that accurately and consistently measure a test taker's competence in the associated subject matter. Psychometric properties of a test item 102 may include difficulty (what proportion of test takers answer the item correctly), discrimination (the correlation between an item score and the total score on the test), and reliability (the degree to which results on the items are consistent between administrations, or with each other). Other psychometric properties may be measured, including but not limited to guessing (the odds of making a correct response when the test taker lacks the necessary level of expertise) and slipping (the odds that a test taker with sufficient expertise will still get the item wrong).

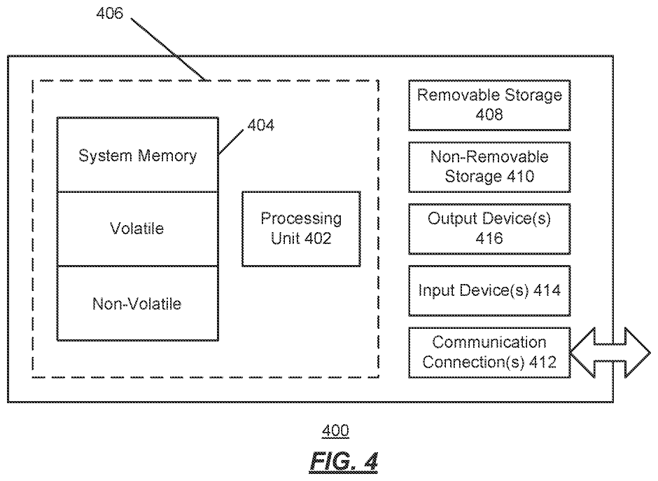

To facilitate the generation of test items 102, the system 101 may include an item model 107 and an item generator 115. The item model 107 may be a model that is trained to score an item 102 on one or more psychometric properties. The model 107 may be a machine learning model (e.g., neural network) that is trained using items 102 that have been labeled with their associated psychometric properties as determined by a human reviewer. Any method for training a model may be used. The system 101 may be implemented using one or more general purpose computing devices such as the computing device 400 illustrated with respect to FIG. 4.

In another embodiment, rather than use an item model 107, one or more human reviewers may be tasked with scoring items 102 for the system 101. These human reviewers may be experts in an associated subject matter. Depending on the embodiment, multiple human reviewers may be used. For example, the assigning of scores to items 102 may be crowdsourced to a set of human reviewer volunteers in a particular field. Items that have been scored by the item model 107, or human reviewers, is referred to herein as the scored items 109. Depending on the embodiment, each human reviewer may be presented with an item 102 by the system 101 using a graphical user interface. The reviewer may then provide their score or scores for the item 102 through the graphical user interface and the system 101 may record the provided score or scores for each item 102.

The item generator 115 may be a model, process, or algorithm that given a prompt 116 will generate a set of generated items 117. The prompt 116 may indicate a desired number of items 102 for the set of generated items 117 and may further include example or reference items 102 for the item generator 115 to consider when generating the set of generated items 117. Depending on the embodiment, the example or reference items 102 may include items 102 with desirable psychometric properties, or some combination of desirable or undesirable psychometric properties. Suitable item generators 115 include NLP-based generative large language models (LLMs) or LLM-based systems such as Chat GPT (e.g., GPT 3.5 or GPT 4). Other models, processes, or algorithms may be used.

The item generator 115 and model 107 may be used to generate, update and improve the quality of items 102 in an item bank 108. These items 102 from the item bank 108 may be used for a variety of purposes including generation of one or more tests 130 that can be presented to one or more users.

Initially, the system 101 may receive an item bank 108 that includes items 102 that were generated by one or more experts. These items 102 may be items 102 that were previously used on one or more tests 130 for a particular subject matter. The items 102 may have been pre-selected as high quality items 102 by one or more reviewers.

The system 101 may use the item model 107 to score the items 102 in the item bank 108. The items 102 from the item bank 108 with the associated scores are the scored items 109. The scores may be based on psychometric qualities and may include difficulty, discrimination, and reliability. Depending on the embodiment, rather than using an item model 107, the scores may be generated by one or more human reviewers or human experts.

The system 101 may sort or rank the scored items 109 by one or more properties of interest. For example, the system 101 may sort the scored items 109 based on psychometric qualities such as difficulty or discrimination. Other properties or combinations of properties may be used to sort the scored items 109. In some embodiments, the lowest ranked scored items 109 may be discarded or removed from the item bank 108. Alternatively, no scored items 109 may be removed as the system 101 may use both low and high ranked scored items 109 for prompt 116 generation.

The system 101 may generate a prompt 116 for the item generator 115 using a subset of the items 102 in the scored items 109. The system 101 may consider each psychometric quality separate. For example, initially the subset of the items 102 may be items selected from the quality of difficulty, a next subset may focus on the quality of discrimination. Alternatively, or additionally, the subset may be based on a combination of psychometric qualities.

Depending on the embodiment, the items 102 in the subset may be the k-highest ranked items 102, and/or the lowest k-ranked items 102. The prompt 116 may ask for x-number of items 102 that are like the k-highest ranked items 102 of the scored items 109. Alternatively, or additionally, the prompt 116 may ask for x-number of items 102 that are dissimilar from the k-lowest ranked items 102 of the scored items 109.

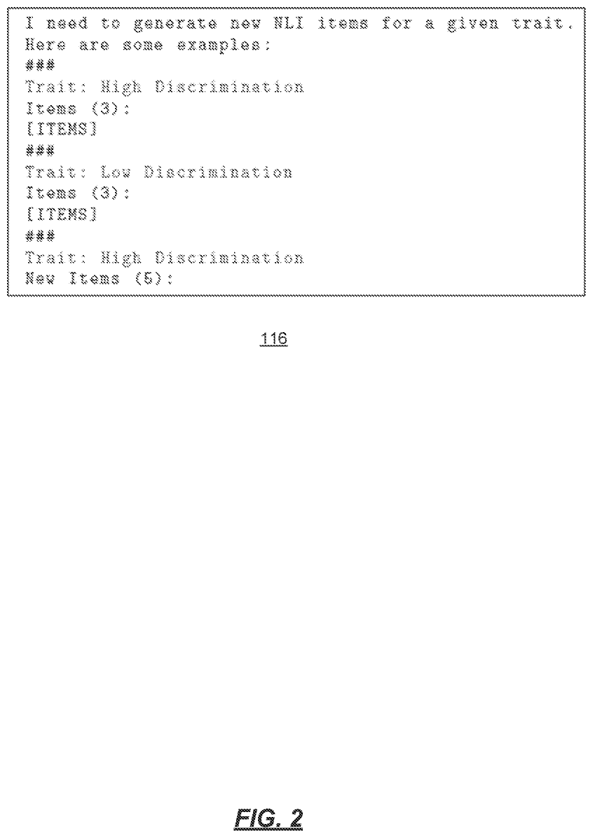

An example prompt 116 is illustrated in FIG. 2. In the example shown, the prompt 116 is for items 102 with high discrimination qualities. The prompt 116 includes three example items 102 with high ranks for discrimination (i.e . . . , “high discrimination”), and three example items 102 with low ranks for discrimination (i.e . . . , “low discrimination”). The “[ITEMS]” of FIG. 2 may refer to a template that may be filed with either human or AI-generated items 102 for which psychometric properties were already computed.

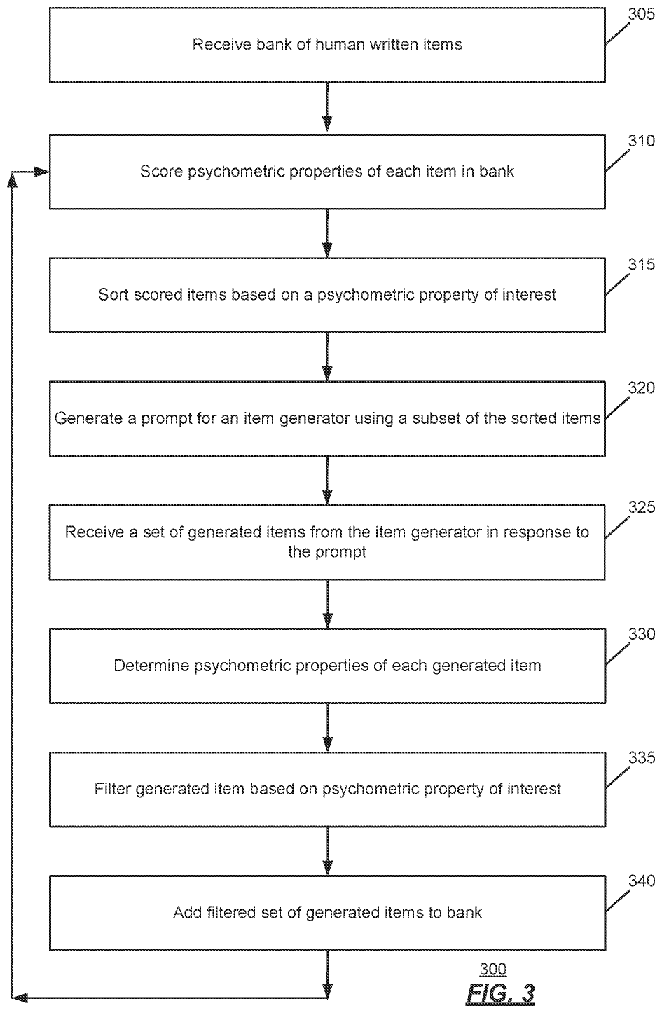

The item generator 115 may receive the prompt 116 and may generate a set of generated items 117 in response to the prompt 116. Returning to the example of FIG. 3, the prompt 116 resulted in the item generator 115 generating five new generated items with allegedly high discrimination.

In response to the generated items 117, the system 101 may use the item model 107 (or expert reviewers) to generate psychometric scores for the items 102 of the generated items 117. Those items 102 with scores that are above a threshold score (indicating that the items 102 are of a minimum quality), may be added to the item bank 108, and those items 102 with scores that are below the threshold may be discarded.

In some embodiments, the scores for the items 102 of the generated items may be based on some or all of the following criteria: relevance, clarity, harmfulness, and certainty. Other criteria may be used.

Relevance may be a measure of how useful the item 102 is for measuring the associated construct. Clarity may be a measure of how clear the wording of the item 102 is including whether it contains any spelling or grammatical errors. Harmfulness may be a measure of whether the item 102 includes any potentially harmful or offensive content. This may include content related to race, ethnicity, religion, or any other identifiable characteristic that may be considered offensive. Certainty may be measure of the overall certainty that a reviewer has in the scores they provided for the relevance, clarity, and harmfulness criteria.

Depending on the embodiment, the system 101 may repeat the above-described process using the item bank 108 that now includes some or all of the generated items 117 from the item generator 115. After each iteration the number of items 102 in the item bank 108 will increase, and the ratio of human generated items 102 to computer-generated items 102 will decrease.

The system 101 described herein provided many advantages over the prior art. First, by using a large language model to generate new items 102, the time and expense required to generate new items 102 is greatly reduced. As may be appreciated, generating items 102 such as questions for tests 130 is an expensive and time consuming task. By leveraging existing large language models to generate items 102 using top scoring (or low scoring) items 102 as prompts 116, the cost of obtaining new items 102 using the system 101 is much lower than traditional methods for item 102 generation. Second, by using a trained item model 107 to automatically score items 102 on one or more psychometric properties, the costs and time associated with human expert reviewers is avoided.

FIG. 3 is an illustration of example method 300 for generating items 102. The method 300 may be performed by the item model 107 and the item generator 115 of the system 101.

At 305, a bank of human created items is received. The items 102 in the item bank 108 may be generated by one or more experts and may be suitable for use in a test 130. The bank 108 may include items 102 such as questions that were previously used in one or more tests 130. In particular, the items 102 in the bank 108 may have been selected based on psychometric properties of the items such as difficulty, discrimination, and reliability. Other properties may be supported.

At 310, psychometric properties of each item in the bank are scored. In one embodiment, the psychometric properties may be scored using the item model 107 that has been trained to score psychometric properties of items 102. In another embodiment, one or more human experts may score the psychometric properties of each item 102.

At 315, the scored items are sorted based on a psychometric property of interest. The scored items 109 may be sorted by the system 101. The psychometric property (or properties) of interest may be selected by a user or administrator.

At 320, a prompt is generated. The prompt 116 may be generated by the system 101. The prompt 116 may be for an item generator 115 and may indicate the number of generated items 117 that are desired and may include the top-k scored items 109 and the bottom-k scored items. The item generator 115 may be a large language model such as Chat GPT, for example.

At 325, a set of generated items is received. The set of generated items 117 may be received from the item generator 115. The set of generated items 117 may be generated by the item generator 115 based on some of all of the scored items 109 provided in the prompt 116.

At 330, psychometric properties of each generated item are determined. The psychometric properties may be determined by the item model 107 and/or one or more expert reviewers. In some embodiments, the expert reviewers may score the generated items on additional factors such as relevance, clarity, harmfulness, and certainty. Other factors may be considered when generating the scores.

At 335, the generated items are filtered based on a psychometric property of interest. The generated items 117 may be filtered by removing any item 102 having a score for the property of interest that is below a threshold. The threshold may be set by a user or administrator. In some embodiments, rather than compare the scores to a threshold, the system 101 may rank the generated items by their scores and may remove some percentage of the items (e.g., bottom ten percent or bottom 20 percent) based on the scores.

At 340, the filtered items are added to the item bank. The filtered items 113 may be added by the system 101 to the item bank 108. The method 300 may repeat until a desired number of items 102 have been added to the item bank 108 with selected psychometric properties. In some embodiments, the filtered items may be used as questions in one or more tests 130, for example.

With reference to FIG. 4, an exemplary system for implementing aspects described herein includes a computing device, such as computing device 400. In its most basic configuration, computing device 400 typically includes at least one processing unit 402 and memory 404. Depending on the exact configuration and type of computing device, memory 404 may be volatile (such as random access memory (RAM)), non-volatile (such as read-only memory (ROM), flash memory, etc.), or some combination of the two. This most basic configuration is illustrated in FIG. 4 by dashed line 406.

Computing device 400 may have additional features/functionality. For example, computing device 400 may include additional storage (removable and/or non-removable) including, but not limited to, magnetic or optical disks or tape. Such additional storage is illustrated in FIG. 4 by removable storage 408 and non-removable storage 410.

Computing device 400 typically includes a variety of computer readable media. Computer readable media can be any available media that can be accessed by the device 400 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 404, removable storage 408, and non-removable storage 410 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 400. Any such computer storage media may be part of computing device 400.

Computing device 400 may contain communication connection(s) 412 that allow the device to communicate with other devices. Computing device 400 may also have input device(s) 414 such as a keyboard, mouse, pen, voice input device, touch input device, etc. Output device(s) 416 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), graphic processing units (GPUs), tensor processing units (TPUs), quantum computing devices, etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
receiving a plurality of items by a computing device;
placing the items of the plurality of items in an item bank by the computing device;
for each item in the item bank, generating a score for at least one psychometric property of the item by the computing device;
sorting each item in the item bank based on the generated scores by the computing device;
generating a prompt for an item generator based on the sorted items by the computing device;
receiving a generated set of items from the item generator based on the generated prompt by the computing device; and
adding at least some of the generated set of items to the item bank by the computing device.

2. The method of claim 1, further comprising:
for each item in the generated set of items, generating a score for at least one psychometric property of the item;
filtering the generated set of items to remove items with generated scores that are below a threshold; and′
adding the remaining items from the generated set of items to the item bank.

3. The method of claim 1, further comprising generating a test using at least some of the items in the item bank.

4. The method of claim 1, wherein the items are test items.

5. The method of claim 1, wherein the psychometric property comprises one of difficulty, discrimination, and reliability.

6. The method of claim 1, wherein the score is generated by an AI model.

7. The method of claim 1, wherein the score is generated by expert reviewer.

8. The method of claim 1, wherein the item generator comprises Chat GPT or another AI content generator.

9. The method of claim 1, wherein the items comprise text items, image items, and video items.

10. The method of claim 1, wherein generating the prompt for an item generator based on the sorted items comprises:
selecting the items from the item bank with the top-k scores;
selecting the items from the item bank with the bottom-k scores; and
generating the prompt for the item generator using the top-k scores and the bottom-k scores.

11. A system comprising:
at least one computing device; and
a non-transitory computer-readable medium with computer-executable instructions stored thereon that when executed by the at least one computing device cause the at least one computing device to:
receive a plurality of items;
place the items of the plurality of items in an item bank;
for each item in the item bank, generate a score for at least one psychometric property of the item;
sort each item in the item bank based on the generated scores;
generate a prompt for an item generator based on the sorted items;
receive a generated set of items from the item generator based on the generated prompt; and
add at least some of the generated set of items to the item bank.

12. The system of claim 11, further comprising:
for each item in the generated set of items, generating a score for at least one psychometric property of the item;
filtering the generated set of items to remove items with generated scores that are below a threshold; and
adding the remaining items from the generated set of items to the item bank.

13. The system of claim 11, further comprising generating a test using at least some of the items in the item bank.

14. The system of claim 11, wherein the items are test items.

15. The system of claim 11, wherein the psychometric property comprises one of difficulty, discrimination, and reliability.

16. The system of claim 11, wherein the score is generated by an AI model.

17. The system of claim 11, wherein the score is generated by expert reviewer.

18. The system of claim 11, wherein the item generator comprises Chat GPT or another AI content generator.

19. The system of claim 11, wherein generating the prompt for an item generator based on the sorted items comprises:
selecting the items from the item bank with the top k scores;
selecting the items from the item bank with the bottom k scores; and
generating the prompt for the item generator using the top k scores and the bottom k scores.

20. A non-transitory computer-readable medium with computer-executable instructions stored thereon that when executed by at least one computing device cause the at least one computing device to:
receive a plurality of items;
place the items of the plurality of items in an item bank;
for each item in the item bank, generate a score for at least one psychometric property of the item;
sort each item in the item bank based on the generated scores;
generate a prompt for an item generator based on the sorted items by:
selecting the items from the item bank with the top k scores;
selecting the items from the item bank with the bottom k scores; and
generating the prompt for the item generator using the top k scores and the bottom k scores;
receive a generated set of items from the item generator based on the generated prompt; and
add at least some of the generated set of items to the item bank.
